(19) United States
(12) Patent Application Publication
(10) Pub. No.: US 2005/0242658 A1
(43) Pub. Date: Nov. 3, 2005

(54) Bicycle wheel

(76) Inventors: Lawrence E. Carlson, Santa Clarita, CA (US); Drew A. Krah, Vashon, WA (US); Bradly S. Hunter, Long Beach, CA (US)

Correspondence Address: BLACK LOWE & GRAHAM, PLLC, 701 FIFTH AVENUE, SUITE 4800, SEATTLE, WA, 98104, US

(21) Appl. No.: 10/836,009

(22) Filed: Apr. 30, 2004

(51) Int. Cl. B60B 21/06

(52) U.S. Cl. 301/58

(57) ABSTRACT

The present disclosure includes a bicycle wheel having a hub, a plurality of spokes, and a rim. The spokes are connected to the hub, each spoke having two ends and a major axis. The ends of each spoke are substantially aligned with the major axis of such spoke. The rim provides a plurality of fixed spoke mounts secured to the spokes. The spoke mounts provide stress grading, in one preferred embodiment by decreasing in section as they extend away from the main body of the rim toward the hub. The spoke mounts are formed integrally with the rim and avoid the use of holes through the wall of the rim that seats the tube. Spoke adjustment mechanisms for straight spokes attached to such spoke mounts are also provided. The disclosure also includes a method of constructing a wheel.

### FIELD OF THE INVENTION

This invention relates generally to spoked wheels and, more specifically, to a light weight, fatigue resistant bicycle wheel with a straight spoke arrangement.

### BACKGROUND OF THE INVENTION

Many have attempted to design light weight, durable wheels, from wagon wheels to bicycle wheels for both road and mountain bikes. Low weight becomes especially important in wheel applications for human powered machines, such as bicycles since the rider can provide only a small amount of horsepower. Furthermore, mass at or near the periphery of a wheel requires more effort to accelerate due to the inertial forces that must be overcome to rotate the mass. However, weight reduction of a wheel must be carried out carefully to maintain durability. Low weight is of little help if the wheel breaks, especially without ease of repair.

Most bicycle wheels include a rim that accepts a tire, a hub that mounts to an axle, and spokes that support tension between the hub and rim. Rim thicknesses have been reduced in certain designs. However, some structural mass is required to maintain a strong connection to the spokes. Spokes have typically been threaded to a nipple fed through the outer portion of the rim under the tube and tire mount location. This has required radial holes in the rim through which to insert the nipples. Such holes cause weakness and stress risers in the rim due to the discontinuous structure. The rim must be strengthened in surrounding areas, adding weight. Furthermore, the holes require coverage with rim tape or rubber strips to protect the tube from expanding into the holes, abrasion, and punctures. The tape or rubber also adds weight. With the spoke-attaching nipples inserted through the rim, deflation and removal of the tire is required when replacing broken spokes. The holes are also very difficult to seal against tire pressure, preventing the use of tubeless tires.

Standard spokes are also unreliable. Such spokes include a 90 degree bend with a mushroomed head adjacent the bend. The opposite end of the spoke includes threads to engage the rim-supported nipples. Such spokes may include reduced center sections (butted spokes) to reduce weight. However, such spokes typically fail at the bend, leaving the cyclist, at best, with a wheel out of true that rubs on the brake pads. The cyclist may even be stranded with an unridable bicycle or injured in a related fall.

Attempts to solve these problems have not been satisfactorily successful. A patent to Mercat (U.S. Pat. No. 6,402,256) discloses a rim that does not include nipple insertion through the tube/tire mounting location. Instead a separate inner wall or “bridge” connecting two sidewalls is provided in the rim apart from the outer wall or bridge upon which the tube would sit. Holes extend through this inner wall into which “end pieces” may be secured for connection to the spokes. The inner wall must be strong enough to deal with the tensile spoke forces and metal fatigue caused by spoke force variation during riding. The wall must also accommodate the relatively large end-piece holes. Thus the bridge is formed with a large thickened wall section surrounding the holes that extend toward the inside of the casing. An additional process of “flow drilling” is required at the holes to create the “chimney-like” structure for securing the end pieces. Thus while Mercat provides a good seat for the tube and tire, the bridge arrangement adds weight and complexity to the rim and its production. The Mercat spoke attachment still suffers from broken spoke problems, not simply due to the 90 degree bend at the hub, but also due to the stress concentration at the rim attachment. A stress concentration is created at the first thread. Further problems discussed above are also left unsolved.

A patent to Rasmussen (U.S. Pat. No. 5,487,592) discloses attempts to solve problems relating to the stress risers in the bend of conventional spokes by providing a system that employs straight spokes, threaded at both ends. The outer ends, however, are secured with nipples inserted through the rim in a conventional manner—creating holes in the tube/tire seating location. Thus the integrity of the seat is compromised and spokes cannot be replaced without removal of the wheel from the frame and the tire from the rim. The Rasmussen arrangement also suffers from stress concentration on the spokes at the first thread, as discussed above.

The rim disclosed in a patent to Herting (U.S. Pat. No. 6,425,641) achieves a tube/tire seat without holes but requires an additional bend in the spoke at the rim attachment. Further, Herting may not be suitable for tubeless tires as the rim is of multi-part construction with a joint in the seat.

Two patents to Dietrich (U.S. Pat. Nos. 6,428,113 and 5,931,544) disclose a front hub mounting system combining a few straight spokes with bent spokes. The system requires that all spokes be inserted through the rim, with attendant holes. The straight spokes used are secured to the middle of the front hub (on the center plane of the wheel). Thus they are of limited application and the wheel still suffers from the disadvantages discussed above.

Therefore, an unmet need exists for a bicycle wheel arrangement that is lightweight and easy to manufacture, that also reduces the tendency for spokes to break and simplifies spoke replacement.

### SUMMARY OF THE INVENTION

The present invention includes a bicycle wheel having a hub, a plurality of spokes, and a rim. The spokes are connected to the hub, each spoke having two ends and a major axis. The ends of each spoke are substantially aligned with the major axis of such spoke. The rim provides a plurality of fixed spoke mounts secured to the spokes. The spoke mounts decrease in section as they extend away from the main body of the rim.

In accordance with one aspect of the invention, the spoke mounts are integrally formed with the rim. The rim also includes a tire mounting structure on the exterior side of the rim opposite the spoke mounts. The tire mounting structure includes sidewalls and a bottom wall. The bottom wall is preferably free from spoke assembly openings.

In accordance with a further aspect of the invention, one end of each of the straight spokes is in direct threaded engagement with a respective spoke mount.

In accordance with a further aspect of the invention, one end of each of the straight spokes is in direct engagement with a respective spoke mount. The engagement interface is preferably threaded, as is the spoke mount for receiving the spoke threads. In an alternate embodiment, one of the ends of each of the spokes is conically shaped. In this embodiment, the spoke decreases in section as it extends inward through at least a portion of the spoke mount. In another aspect, the spoke mounts include holes into which the spokes are mounted. Each of the outer ends of the spokes includes a portion of increased section larger than the holes.

In accordance with another aspect of the invention, each of said spoke mounts includes an attachment portion configured to disperse the tensile load from the spoke mounted thereto beyond the initial engagement at the inward end of the mount. Each spoke mount includes a threaded end within which internal threads are disposed. In one embodiment, stress grading (i.e., load dispersion) is accomplished with at least one external side of the mount being sloped inward toward the threaded end. In a preferred embodiment of the invention all sides slope inwardly toward the threaded end. In accordance with a further aspect of the invention, a ferrule abuts the threaded end of the spoke mount. The ferrule has a substantially frustoconical shape and a bore for receiving a spoke.

In accordance with yet further aspects of the invention, the spoke mount external side slopes non-linearly along a substantially circular path. In alternative embodiments, the path of curvature is parabolic, oval, or hyperbolic.

Another aspect of the invention includes a spoke mount having two sets of internal threads. Such threaded holes are side-by-side for receiving the outer ends of two spokes, such as paired spoke designs.

Still another aspect of the invention includes a spoke mount having a threaded end within which the internal threads are recessed from the inward leading end of the mount.

Preferably the spoke mounts extend inwardly from the interior of the rim, each spoke mount having an internal threaded hole for securing a respective spoke. Such holes are situated with at an angle from the rim within seven degrees laterally and 20 degrees longitudinally from a radial line extending from the rim to the hub.

In accordance with other aspects of the invention, spoke adjustment mechanisms secure the spokes to the spoke mounts. Such mechanisms allow spoke tension adjustment. In one embodiment the spoke adjustment mechanisms comprise turnbuckles secured between the spoke mounts and the spokes. Alternate arrangements for the turnbuckle are provided herein. In one arrangement, the turnbuckles comprise barrels and links coupling the barrels to the spoke mounts. Each of the barrels include right-hand threads within one end for engaging the spokes and left-hand threads within the opposite ends to engage the links. In another arrangement, the barrels include relatively course threads within one end receiving a respective one of the spokes. Relatively fine threads are disposed in the opposite ends, receiving a respective one of the links. In still another embodiment of an adjustment mechanism, an adjustment nipple is rotatably coupled to a spoke mount. The nipple has an internally threaded end coupled to a spoke.

The adjustment mechanism turnbuckles may each alternatively include a body having a threaded recess in one end and a stud projecting from the opposite end. The threaded recess receives a spoke. The stud engaged at least one of the spoke mounts. The stud may be integrally formed with the outer body or may be a separately inserted part. The body includes flats on the exterior thereof for facilitation of turning the body for spoke tensioning adjustment. The stud is preferably left-hand threaded, such that rotation of the body selectively loosens or tightens the spoke.

In accordance with yet another aspect of the invention, spoke adjustment mechanisms are secured between the hub and the spokes. Such mechanisms provide tension adjustment for the spokes. The spoke adjustment mechanisms include threaded adjustment nipples. Each nipple is rotatably secured to the hub and has a threaded end for engagement with one of the spokes.

The present invention also includes a method of securing a wheel rim to a hub. The steps of the method include providing a plurality of straight spokes, threaded on both ends. One end of each spoke is threaded into a fixed mount on the rim. The opposite end of each spoke is threaded into a rotatable nipple secured to the hub. Preferably a ferrule is placed on one end of a spoke before threading that end into the fixed mount on the rim. The invention further includes a bicycle rim constructed with an extrusion and machining process. The process begins with extruding a metal into a shape including a tire engaging portion, an intermediate wall, and a center flange opposite the tire engaging portion. Portions of the center flange are machined away to leave spoke mount projections. The projections decrease in section as they extend away from the intermediate wall. Preferably, the height of each spoke mount projections is at least ten percent of the width. More preferably, the height is at least one-fourth of the width. Threaded holes are created in the ends of the spoke mount projections for receiving spokes. The metal is formed into a substantially circular shape with the angle of each of the threaded holes being within seven degrees laterally and 20 degrees longitudinally from a radial line extending from the rim.

The invention also includes a spoke for engaging a hub and a rim. The rim has spoke apertures. The spoke includes first and second ends and a shaft. The first end engages one of the apertures with a portion having a section larger than the aperture. The second end is engageable with the hub. The second end and shaft have sections no larger than the aperture such that they may be inserted therethrough.

In one preferred embodiment, the invention includes a bicycle rim constructed by a process including forming a rim with a threaded mount and inserting a spoke into the rim. The mount is a fixed spoke mount projecting inwardly from the interior of the rim. The mount has internal threads for securing a spoke and has a decreasing section as the mount extends inwardly. The spoke includes a shaft portion and a threaded portion. The spoke is inserted into the threaded portion of the mount such that at least a portion of the shaft portion of the spoke is forced into an interference fit with the threads in the inward end of the mount. Preferably, the spoke threads include an outer diameter greater than the spoke shaft diameter. Alternatively the spoke threads include an outer diameter no larger than the spoke shaft diameter.

As may be appreciated from the foregoing summary, the invention provides a bicycle wheel with a lightweight rim and fatigue resistant spoke arrangement. The spokes are also easy to replace without tire or wheel removal or even tire depressurization. Further, the integrity of the tire/tube portion of the rim simplifies the rim and minimizes flats. Tubeless tires may more easily be employed with the present arrangement.

### BRIEF DESCRIPTION OF THE DRAWINGS

The preferred and alternative embodiments of the present invention are described in detail below with reference to the following drawings.

FIG. 1 is a partial side view of a bicycle wheel of the present invention;

FIG. 2 is an isometric view of a section of a rim and spoke, illustrating a cross section of the rim;

FIG. 3 is a schematic side view of a portion of a rim-spoke-hub assembly showing the interconnections between these elements;

FIG. 4 is an end elevational view of a portion of a wheel showing the hub-to-spoke attachments;

FIG. 5 is a magnified partial view of the drive side of the hub of FIG. 4;

FIG. 6a is a magnified sectional view of one embodiment of the spoke mount of the present invention with a circular fore and aft profile;

FIG. 6b is a magnified sectional view of one embodiment of the spoke mount of the present invention with a parabolic fore and aft profile;

FIG. 6c is a magnified sectional view of one embodiment of the spoke mount of the present invention with an oval fore and aft profile;

FIG. 6d is a magnified sectional view of one embodiment of the spoke mount of the present invention with a hyperbolic fore and aft profile;

FIG. 7 is a magnified sectional view of a spoke having the shaft force fit into the mount;

FIG. 8 is a cross-sectional view of a rim having a spoke mount with inwardly sloped lateral sides;

FIG. 9a is a magnified side elevational view of a rim section with a dual spoke mount;

FIG. 9b is a magnified side elevational view of a rim section with paired separate spoke mounts;

FIG. 10 is a partial exploded isometric view of spoke mount, spoke, and ferrule;

FIG. 11 is a schematic side view of a portion of a rim-spoke-hub assembly showing the interconnections between these elements with a turnbuckle adjustment mechanism;

FIG. 12 is a cross-sectional view of an alternate turnbuckle assembly; and

FIG. 13 illustrates an embodiment of an adjustment mechanism with a turnbuckle having a stud projecting from one end thereof;

FIG. 14 is a side view of an integrated turnbuckle member;

FIG. 15 shows an alternate spoke attachment arrangement with a conical section on the outer end of the spoke and a corresponding opening in the spoke mount; and

FIG. 16 shows yet another spoke to mount configuration.

### DETAILED DESCRIPTION OF THE PREFERRED EMBODIMENT

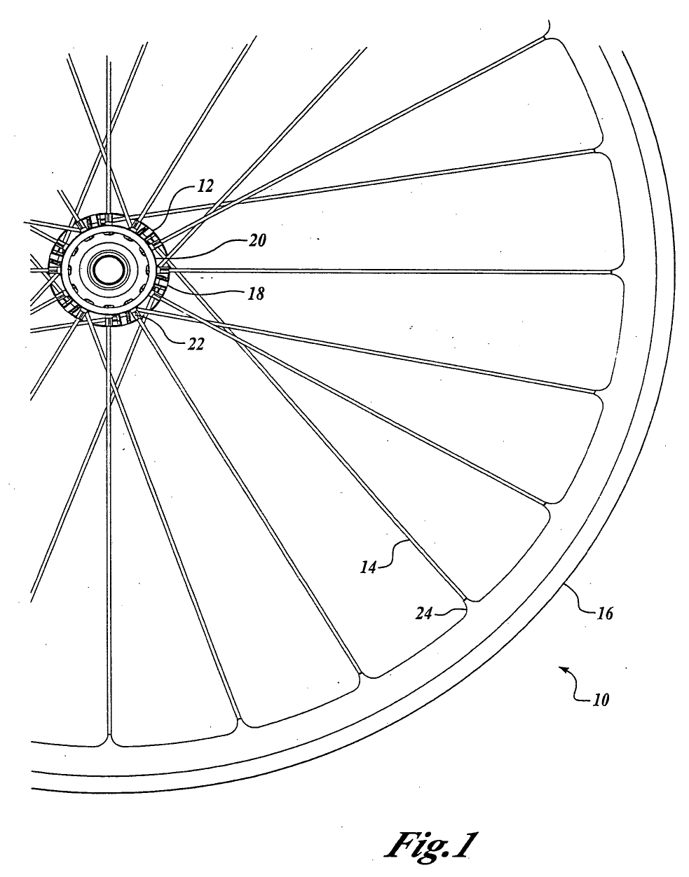

FIG. 1 illustrates a bicycle wheel 10 constructed according to the present invention. Wheel 10 includes a hub 12, spokes 14 extending outwardly from hub 12 and a rim 16 to which the outer ends of spokes 14 are secured. Most conventional wheels include a hub, spokes, and a rim. However, the wheel 10 of the present invention includes novel fastening and tightening mechanisms for interconnecting spokes 14 to rim 16 and hub 12.

Hub 12 includes a drive side 18 and non-drive side 20. Drive side 18, typically the right side of hub 12, allows for securement of rear sprockets to which a chain is entrained for driving the wheel forward. Alternatively, the wheel construction can also be made for a front wheel, which does not include a drive side. In such an instance the construction is preferably more similar to non-drive side 20 on both sides of such wheel.

In the embodiment shown in FIG. 1, nipples 22 secure spokes 14 to hub 12. The securement of nipples 22 to hub 12 will be described in more detail below in connection with FIGS. 3 through 5. At the outer ends of spokes 14, spoke mounts 24 secure threaded ends of spokes 14 to rim 16.

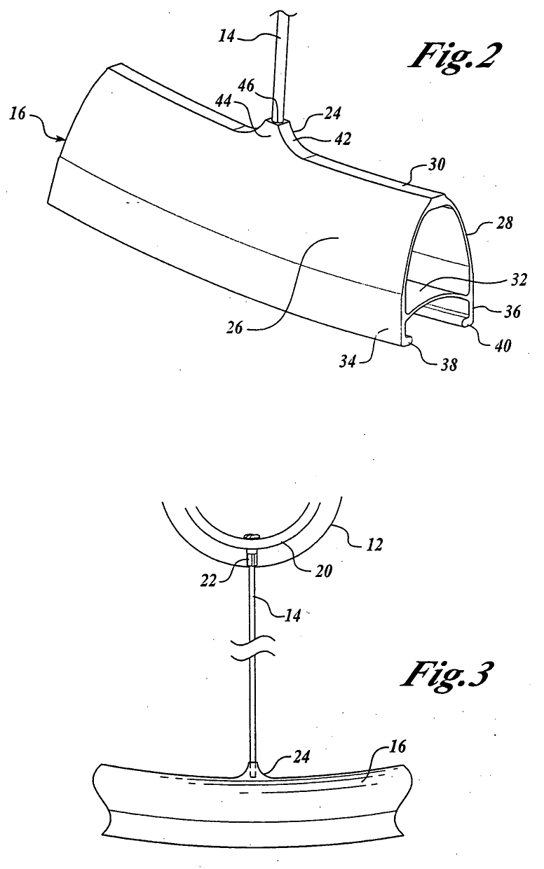

Referring now to FIG. 2 the details of rim 16 will be disclosed. Rim 16 is preferably formed from an extruded aluminum alloy to form an “A” shape in cross-section. Rim 16 includes sidewalls 26 and 28 forming the sides of the A shape and joining together at the tops thereof to form a ridge 30. Sidewalls 26 and 28 are joined near the other ends thereof by a wall 32 spanning from one sidewall to the other. Outward of wall 32, rim flanges 34 and 36 with butts 38 and 40 complete sidewalls 26 and 28. The thickness of sidewalls 26 and 28 varies. Ridge 30 is somewhat thicker in the preferred embodiment while the portion between wall 32 and ridge 30 is somewhat thinner in section to keep the weight low. The portion of sidewalls 26 and 28 adjacent wall 32 is somewhat thicker for structural integrity and also to provide a breaking surface. This portion of sidewalls 26 and 28 may also have a flat outer surface for engagement with brake pads (not shown). Wall 32 preferably has a slightly arched shape. This inward slope toward the center of wall 32 is provided to ease tire mounting, as it allows one side of the tire to be shifted inwardly to the middle of wall 32 while the tire sidewalls are being forced over the opposite side of the rim. The curvature also helps seat the tire beads uniformly around the rim against flanges 34 and 36 and butts 38 and 40 when the tire is being pressurized. Wall 32 also provides a smooth seat for a tube or provides a continuous closed wall for a tubeless tire. Wall 32 is continuous except for a valve stem opening. Flanges 34 and 36, in combination with butts 38 and 40, provide a seat for holding the beads of a tire. Thus, butts 38 and 40 project inwardly towards each other from rim flanges 34 and 36.

Spoke mount 24 is also shown in more detail in FIG. 2. Spoke mount 24 includes fore/aft walls 42 that slope toward the inward end of spoke mount 24 into which spoke 14 is inserted. Mount sidewalls 44 are also provided and are preferably an integral inward extension of ridge 30. A bore 46 extends into spoke mount 24 beginning at the inward end thereof. Bore 46 holds spoke 14 securely therein.

Rim 16 is preferably constructed by extruding a material into the A shape with an extended ridge 30. After the extrusion process, ridge 30 is then machined down to its final height to form spoke mounts 24 extending integrally inward therefrom. Rim 16 is preferably curved into a circular shape with the ends welded together to form a circular rim 16. This curving into a circular rim may be performed before or after the machining process to form spoke mounts 24. In the preferred embodiment, the steps of machining to form spoke mounts 24 and drilling bores 46 are carried out before the extruded material is curved to form rim 16 into a circular shape.

FIG. 3 is a semi-schematic view of the basic hub-spoke-rim assembly. A non-drive side 20 of hub 12 is illustrated. Spoke 14 is secured to hub 12 with nipple 22. Nipple 22 extends to an aperture in hub 12. The outer end of spoke 14 is threaded into spoke mount 24 extending inwardly from rim 16. Spoke 14 may be tightened by rotating nipple 22. To that end, nipple 22 includes flat sides thereon for use with a spoke wrench. This basic arrangement allows for the use of straight spokes having threads at both ends. Thus, stress risers are eliminated and spoke life is lengthened. Furthermore, due to the shape of spoke mount 24 tapering from a wider base into a narrower inward end, stress grading is accomplished such that the first thread of the spoke does not carry the full tensile load of spoke 14. The load is more evenly distributed along more threads of spoke 14 secured within spoke mount 24. The inward end of spoke mount 24, being smaller in section, is able to elastically yield slightly as needed for load distribution throughout more threads of spoke 14.

FIGS. 4 and 5 illustrate further details of the securement of spokes 14 to hub 12. Spoke 14 is threaded within nipple 22. Nipple 22 includes a nipple head 48 with a slot therein that may also be used for turning nipple 22 to advance or retract nipple 22 on the threads of spoke 14. The drive side of hub 12 is provided with bosses 50 and recesses 52 for securing nipples 22. Bosses 50 extend radially outward from the main body of hub 12 and have apertures extending therethrough in a direction for securement of nipples 22 and spokes 14 circumferentially around hub 12. Nipple heads 48 extend on the back sides of bosses 50 with nipples 22 extending out the front side and being secured to spokes 14. The spokes may be tightened or otherwise adjusted by turning nipple heads 48 with a screw driver or similar tool. Nipples 22 on the non-drive side and on both sides of a front wheel may be turned with a spoke wrench since tighter boss and recess securement is not required at these non-drive locations.

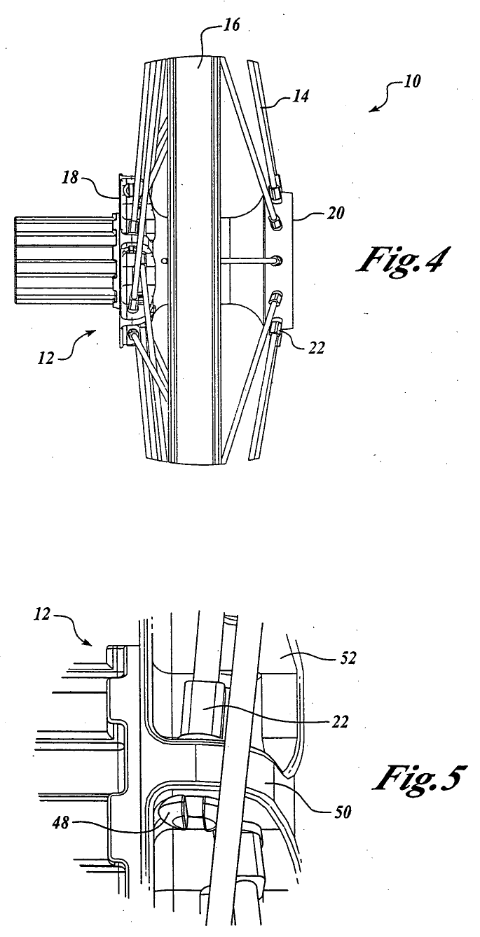

FIGS. 6A through 6D illustrate various configurations of spoke mount 24 to provide different degrees of stress grading. These various embodiments are primarily directed toward the fore/aft walls 42 of spoke mounts 24. However, such sloping walls may also be used on mount side walls 44 as shown in FIG. 8 and FIG. 10. FIG. 6A illustrates the fore/aft wall having a circle 54 defining the curvature thereof. Thus, the fore and aft profile of the spoke mount at the rim is circular to give an increasing section radially outward such that the load is transferred gradually to the threaded part of the spoke along its threaded portion. Alternatively, a wider base embodiment is provided as shown in FIG. 6B with a parabola 56 defining the parabolic curvature of the fore/aft profile. An oval 58 describing the curvature is illustrated in FIG. 6C and a hyperbola 60 is illustrated in FIG. 6D. Any one of these curvatures or others may be employed depending on the materials selected for spokes and rims and the stress grading desired. As is shown, a hyperbolic curvature may be arranged to provide a narrower overall spoke mount profile for increased yielding, either elastic or inelastic as spoke 14 is tightened. Alternatively, a parabolic curve illustrated in FIG. 6B could provide yielding primarily at the inward end of spoke mount 24 as the base could be arranged to widen more aggressively. In any case, the curvatures and the offsets of the curvatures may be used to change the dimensions for desired stress grading.

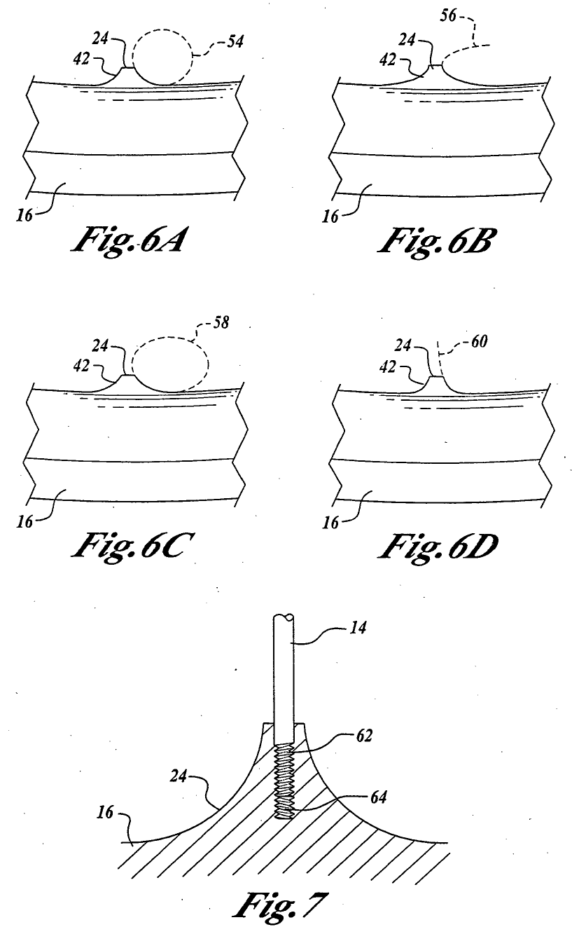

As illustrated in FIG. 7, stress grading can also be effected by forcing spoke 14 into spoke mount 24 beyond spoke threads 62. In this instance, at least a portion of mount threads 64 are deformed as they yield to the shaft of spoke 14. The force fit is especially tight if the spoke threads are cut threads rather than rolled threads. In the case of cut threads the outer diameter of the threads would typically be about the same as the shaft diameter. With rolled threads the outer diameter of the threads would typically be greater than the diameter of the spoke shaft. Of course, shaft and spoke diameters may be altered outside of these general parameters. In this embodiment, the body of spoke 14 is substantially tight in bore 46 above spoke threads 62 and mount threads 64. Stress grading may be enhanced in such embodiments with a tight fit at the entry (i.e., inward end) of spoke mount 24. More of the spoke threads will tend to be firmly engaged as well, distributing the spoke tensile forces for a decrease in any stress concentrations.

FIG. 8 illustrates in cross-section sloping mount sidewalls 44. Thus, the left and right sides of spoke mount 24 slope inwardly to further taper the connection for stress optimization.

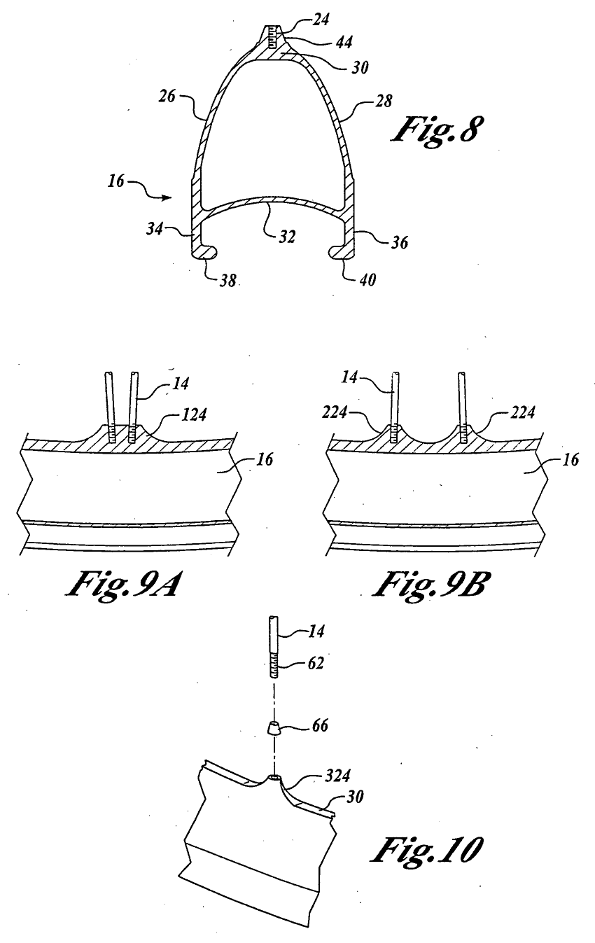

Preferably the angle of bore 46 or spoke 14 from the rim is within plus or minus seven degrees laterally and plus or minus 20 degrees longitudinally from a radial line, to facilitate straight spoke pull without bending. The angle of the spoke will depend upon the width of the hub, as well as whether the spoke is being secured to a drive side of the hub or a non-drive side of the hub or front hub. Alternate embodiments of spoke mounts that may also accommodate various angles are illustrated in FIG. 9A and FIG. 9B. FIG. 9A illustrates an enlarged spoke mount 124 that accommodates a paired spoke attachment. Thus, two bores are made within a single spoke mount 124 in rim 16. Spokes 14 may extend at angles outwardly therefrom for proper joining with the hub. Alternatively, as illustrated in FIG. 9B, the spoke attachments may be paired on separate spoke mounts 224. Such spoke mounts are positioned close together but slightly separated such that each individual mount may provide the proper stress grading. This may be used, for example, with one spoke extending to one side of a hub while the other adjacent paired spoke extends to the opposite side.

FIG. 10 illustrates an alternate embodiment of the spoke and rim assembly of the present invention. In this embodiment a spoke mount 324 has been machined or otherwise formed such that it extends inwardly with sloping sides and a circular cross-section at the inward end thereof. A ferrule 66 is also provided that may be slid on spoke 14 to provide a smooth transition between spoke mount 324 and spoke 14. Ferrule 66 may be generally in the shape of a frustum of a cone with a bore therethrough to accommodate spoke 14. Thus, when threads 62 of spoke 14 are secured within spoke mount 324 ferrule 66 has a wide end that abuts the inward end of spoke mount 324 for a smooth aerodynamic transition.

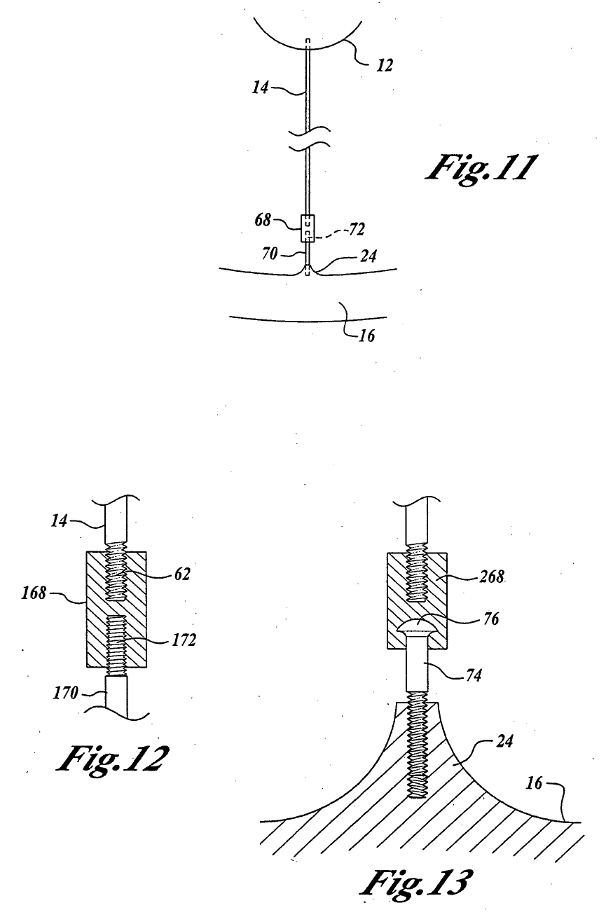

The embodiments illustrated and described above with regard to spoke attachment and mounting disclose primarily hub-side adjustment, preferably with nipples that secure the hub to the inward ends of the spokes. Alternate rim-side or mid-spoke adjustable mountings are also possible with the present invention. FIG. 11 illustrates a semi-schematic view of a straight spoke assembly utilizing a turnbuckle 68 secured to the outward end of spoke 14 with a link 70 securing the outward end of turnbuckle 68 to spoke mount 24 of rim 16. Link threads 72 are provided within turnbuckle 68. Such link threads may be left-hand threaded in order to allow the turnbuckle to adjust the tension on spoke 14. Turnbuckle 68 is preferably a cylindrical body that includes flat wall sections on the outer portion thereof such that a spoke wrench or other tool may be used to rotate turnbuckle 68 about an axis of spoke 14 for adjustment thereof. Link 70 is preferably threaded into spoke mounts 24. The threaded portion of link 70 that engages turnbuckle 68 includes left-hand threads.

An alternative embodiment of a turnbuckle is illustrated in FIG. 12. In this embodiment, right-hand threads may be employed within both ends of a turnbuckle 168. However, finer threads 172 are disposed on link 170 such that turning of the turnbuckle still has net movement effect between link 170 and spoke 14. This is due to the fact that turning of turnbuckle 168 will not move the turnbuckle body as far on fine threads 172 as it will on spoke threads 62 even though both may be right-hand threads.

A further embodiment of a turnbuckle 268 is illustrated in FIG. 13. This embodiment uses a stud link 74 having a stud head 76 rotatably secured within one end of turnbuckle 268. Stud link 74 is threadably engaged within spoke mount 24. A spoke 14 is threaded within the opposite end of turnbuckle 268. Stud head 76 is free to rotate within turnbuckle 268 such that upon turning the turnbuckle progresses up or down spoke 14 for adjustment thereof.

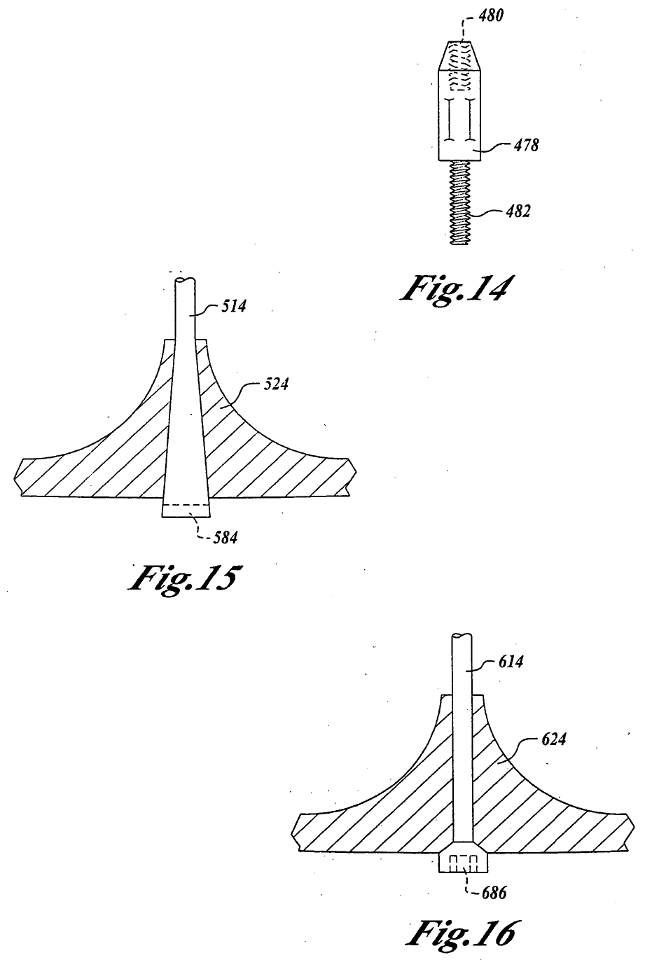

FIG. 14 illustrates an alternate configuration of an adjustable turnbuckle 468. In this embodiment, the turnbuckle includes a body 478 having a recess 480 in one end and a stud 482 projecting from the other end. A spoke is threadably securable to recess 480, which preferably includes mating right-hand threads. Stud 482 is engageable with mount 24, both preferably provided with left-hand threads. Stud 482 may be integrally formed with body 478 or may be a separate attached part. For example, stud 482 may be separately formed and threaded, then force fit or threaded within a bore provided in body 478. Body 478 includes flats about the outer sides thereof to allow the use of a tool for rotating turnbuckle 468 for adjusting spoke tension. Body 478 is provided with a tapered inner end for a transition to a spoke. Such a taper provides a level of stress grading for the connection between the spoke and turnbuckle 468.

In an alternate embodiment, stud 482 and mount 24 are both right-hand threaded with stud 482 having finer threads or coarser threads to allow tensioning adjustment by turning body 478.

FIG. 15 illustrates a spoke and spoke mount configuration wherein the spoke is inserted through the rim. However, stress grading is still provided with the conical interface of the end of the spoke with the spoke mount. No threads are necessary in the spoke mount or the outer end of spoke 514 in this embodiment. The end of spoke 514 increases in section as it extends outwardly such that it forms a generally conical shape in the preferred embodiment. Spoke mount 524 has a complementary shape to engage the outer end of spoke 514. A driver slot 584 is provided in the outer end of spoke 514 to allow the spoke to hold from rotation while it is being tensioned. Tensioning in this embodiment may be accomplished at the hub end of spoke 514 or at an intermediate portion, for example, according to any of the structures described herein.

The embodiment of FIG. 16 is similar in concept to that described above in connection with FIG. 15. In this construction, spoke 614 includes an enlarged end 686 with a hex driver recess. Enlarged end 686 is preferably at least partially tapered at its inner end, which interfaces with the shaft of spoke 614. Once again, the hole through spoke mount 624 is preferably configured to mate with enlarged end 686 and the shaft.

In all of the various embodiments described above, stress concentrations are reduced either by providing straight spokes, or by providing stress grading where spokes are secured. Such constructions will lengthen the life of the spokes. Where spoke replacement is required many embodiments of the present invention also allows such spokes to be replaced without removal of the tire from rim 16 and possibly without the removal of wheel 10 from the bicycle. In many embodiments, both ends of the spokes may be accessed without obstruction by the tire tube or hub. Thus, the present invention provides a spoke-mounting arrangement that is easier to use and maintain while also requiring less maintenance overall due to increased fatigue resistance.

The assemblies described also provide a light-weight system as the spoke mounts are small in size and use very little material, while the stress-grading features of the mounts disperse the load properly into the rim. The fortification around holes in rims that are conventionally used with nipples extending through the rims is not necessary. Furthermore, the elimination of holes through the wall 32 that seats the tube minimizes punctures.

While preferred embodiments of the invention have been illustrated and described, as noted above, many changes can be made without departing from the spirit and scope of the invention. For example, the turnbuckle may be positioned nearer the hub than the rim. Accordingly, the scope of the invention is not limited by the disclosure of the preferred embodiments. Instead, the invention should be determined entirely by reference to the claims that follow.

1. A bicycle rim comprising a fixed spoke mount projecting inwardly from the interior thereof, said mount having internal threads for securing a spoke and a decreasing section as the mount extends away from the rim.

2. The rim of claim 1, wherein said spoke mount is integrally formed with said rim.

3. The rim of claim 2, further comprising a tire mounting structure having sidewalls and a bottom wall, said bottom wall being free from spoke assembly openings.

4. The rim of claim 2, wherein the rim and said spoke mount are formed by extrusion, portions of said extrusion being cut away to form said spoke mount.

5. The rim of claim 1, wherein said spoke mount includes a threaded end within which said internal threads are disposed, and wherein said spoke mount includes at least one external side sloped inward toward said threaded end.

6. The rim of claim 5, wherein all external sides of said spoke mount slope toward said threaded end.

7. The rim of claim 5, wherein said spoke mount external side slopes non-linearly along a substantially circular path.

8. The rim of claim 5, wherein said spoke mount external side slopes non-linearly along a substantially parabolic path.

9. The rim of claim 5, wherein said spoke mount external side slopes non-linearly along a substantially oval path.

10. The rim of claim 5, wherein said spoke mount external side slopes non-linearly along a substantially hyperbolic path.

11. The rim of claim 5, wherein said threaded end of said spoke mount has a substantially circular cross section.

12. The rim of claim 11, further comprising a ferrule abutting said threaded end of said spoke, said ferrule having a substantially frustoconical shape and a bore for receiving a spoke.

13. The rim of claim 5, further comprising a transition insert positioned to abut said threaded end of said spoke mount, said insert having a bore to receive a spoke.

14. The rim of claim 1, wherein said spoke mount includes two sets of internal threads, side-by-side, for receiving two spokes.

15. The rim of claim 1, further comprising a tire mounting structure having sidewalls and a bottom wall, said bottom wall being free from spoke assembly openings.

16. The rim of claim 1, further comprising a plurality of spoke mounts extending inwardly from the interior of the rim, each spoke mount having an internal threaded hole for securing a respective spoke, each said hole having an angle from the rim within 16 degrees laterally and 20 degrees longitudinally from a radial line extending from the rim to the hub.

17. A bicycle wheel comprising:
a) a hub;
b) a plurality of spokes connected to said hub, said spokes each having two ends and a major axis, said ends of each spoke being substantially aligned with the major axis of such spoke; and
c) a rim having a plurality of fixed spoke mounts secured to said plurality of spokes, said spoke mounts decreasing in section as they extend away from said rim.

18. The wheel of claim 17, further comprising spoke adjustment mechanisms secured to said hub and to said spokes for adjusting the tension of said plurality of spokes.

19. The wheel of claim 18, wherein said spoke adjustment mechanisms comprise threaded adjustment nipples each rotatably secured to said hub and having a threaded end for engagement with one of said plurality of spokes.

20. The wheel of claim 19, wherein said spokes are in direct threaded engagement with said spoke mounts.

21. The wheel of claim 20, wherein said spokes are in direct threaded engagement with said spoke mounts.

22. The wheel of claim 19, wherein each of said spoke mounts includes a threaded end within which internal threads are disposed, and wherein each of said spoke mounts includes at least one external side sloped inward toward said threaded end.

23. The wheel of claim 22, further comprising a ferrule abutting said threaded end of said spoke, said ferrule having a substantially frustoconical shape and a bore for receiving a spoke.

24. The wheel of claim 17, wherein said spokes are in direct engagement with said spoke mounts.

25. The wheel of claim 24, wherein said spokes are in threaded engagement with said spoke mounts.

26. The wheel of claim 24, wherein one of said ends of each of said spokes is conically shaped, the spoke decreasing in section as it extends inward through at least a portion of said spoke mount.

27. The wheel of claim 24, wherein said spoke mounts include holes into which said spokes are mounted, and wherein each of the outer ends of said spokes includes a portion of increased section larger than said holes.

28. The wheel of claim 17, further comprising spoke adjustment mechanisms secured to said spoke mounts and to said plurality of spokes for adjusting the tension of said plurality of spokes.

29. The wheel of claim 28, wherein said spoke adjustment mechanisms comprise turnbuckles secured between said spoke mounts and said spokes.

30. The wheel of claim 29, wherein at least one of said turnbuckles comprise a body having a threaded recess in one end for receiving a spoke and a stud projecting from the opposite end for engaging at least one of said spoke mounts.

31. The wheel of claim 30, wherein said body includes an external configuration having flats for facilitation of turning said body.

32. The wheel of claim 30, wherein said stud is left-hand threaded.

33. The wheel of claim 28, wherein said spoke adjustment mechanisms comprise an adjustment nipple rotatably coupled to at least one of said spoke mounts, said nipple having an internally threaded end coupled to a respective one of said spokes.

34. A bicycle wheel comprising:
a) a hub;
b) a plurality of spokes connected to said hub, said spokes each having two ends and a major axis, said ends of each spoke being substantially aligned with the major axis of such spoke; and
c) a rim having a plurality of fixed spoke mounts secured directly to said plurality of spokes.

35. The wheel of claim 34, wherein each of said spoke mounts includes an attachment portion, each of said spoke mounts being configured to disperse the tensile load from the respective spoke beyond the initial engagement with said attachment portion.

36. The wheel of claim 35, wherein each of said spoke mounts tapers to a narrower section as it extends away from said rim to disperse the tensile load.

37. The wheel of claim 36, wherein each said spoke mount includes a threaded end within which said internal threads are disposed, and wherein said spoke mount includes at least one external side sloped inward toward said threaded end.

38. The wheel of claim 37, further comprising a ferrule abutting said threaded end of said spoke mount, said ferrule having a base shape matching said threaded end of said spoke mount and tapering to a smaller section as it extends away from said spoke mount.

39. The wheel of claim 34, further comprising spoke adjustment mechanisms secured to said hub and to said spokes for adjusting the tension of said plurality of spokes.

40. The wheel of claim 39, wherein said spoke adjustment mechanisms comprise threaded adjustment nipples each rotatably secured to said hub and having a threaded end for engagement with one of said plurality of spokes.

41. The wheel of claim 34, further comprising spoke adjustment mechanisms secured to said spoke mounts and to said plurality of spokes for adjusting the tension of said plurality of spokes.

42. The wheel of claim 39, wherein said spoke adjustment mechanisms comprise turnbuckles secured between said spoke mounts and said spokes.

43. The wheel of claim 42, wherein said turnbuckles comprise adjustment barrels and links coupling said barrels to said spoke mounts, each of said barrels including right hand threads on one end for engaging said spokes and left hand threads on the opposite ends to engage said links.

44. The wheel of claim 42, wherein said turnbuckles comprise adjustment barrels and links coupling said barrels to said spoke mounts, each of said barrels including relatively course threads within one end receiving a respective one of said spokes and relatively fine threads within the opposite end receiving a respective one of said links.

45. The wheel of claim 39, wherein each of said spoke adjustment mechanisms comprise an adjustment nipple rotatably coupled to at least one of said spoke mounts, said nipple having an internally threaded end coupled to a respective one of said spokes.

46. The wheel of claim 34, wherein at least one of said spoke mounts is integrally formed with said rim.

47. A method of securing a wheel rim to a hub comprising the steps of:
a) providing a plurality of straight spokes threaded on both ends;
b) threading one end of each of the spokes into a fixed mount on the rim; and
c) threading the opposite end of each such spoke into a rotatable nipple secured to the hub.

48. The method of claim 47, further comprising the step of placing a ferrule on one end of a spoke before threading such end into the fixed mount on the rim.

49. A bicycle rim constructed by the process of:
a) extruding a metal into a shape including a tire engaging portion, an intermediate wall, and a center flange opposite the tire engaging portion;
b) machining away portions of the center flange to leave spoke mount projections, such projections decreasing in section as they extend away from the intermediate wall; and
c) creating threaded holes in the ends of the spoke mount projections.

50. The process of claim 49, wherein the spoke mount projections each include a height and a width, the height being at least ten percent of the width.

51. The process of claim 49, further comprising forming the metal into a substantially circular shape, wherein the angle of the each of the threaded holes is within 16 degrees laterally and 20 degrees longitudinally from a radial line.

52. A spoke for engaging a hub and a rim having spoke apertures, the spoke comprising:
(a) a first end for engaging one of the apertures, said first end having at least a portion thereof with a section larger than the aperture; and
(b) a second end and shaft being no larger in section than the aperture, said second end being engageable with the hub.

53. The spoke of claim 52, wherein said first end includes a conical portion that increases in section as it extends outwardly.

54. A bicycle rim constructed by a process comprising:
(a) forming a rim having a fixed spoke mount projecting inwardly from the interior thereof, said mount having internal threads for securing a spoke and having a decreasing section as the mount extends inwardly; and
(b) inserting a spoke having a shaft portion and a threaded portion into the mount, wherein the spoke is inserted into the threaded portion of the mount such that at least a portion of the shaft portion of the spoke is forced into an interference fit with the threads in the inward end of the mount.

55. The bicycle wheel of claim 54, wherein the spoke threads include an outer diameter greater than the spoke shaft diameter.

56. The bicycle wheel of claim 54, wherein the spoke threads include an outer diameter no larger than the spoke shaft diameter.
